(19) United States
(12) Patent Application Publication
(10) Pub. No.: US 2010/0141069 A1
(43) Pub. Date: Jun. 10, 2010

(54) MOTOR CASE

(75) Inventor: Chuping LU, Zhongshan (CN)

Correspondence Address: MATTHIAS SCHOLL, 14781 MEMORIAL DRIVE, SUITE 1319, HOUSTON, TX, 77079, US

(73) Assignee: ZHONGSHAN BROAD-OCEAN MOTOR CO., LTD, Zhongshan (CN)

(21) Appl. No.: 12/703,215

(22) Filed: Feb. 10, 2010

Related U.S. Application Data
(63) Continuation of application No. 12/141,258, filed on Jun. 18, 2008, now abandoned.

(30) Foreign Application Priority Data
Jul. 31, 2007 (CN) 200720055139.1

(51) Int. Cl. H02K 5/15

(52) U.S. Cl. 310/89

(57) ABSTRACT

A motor case, including at least a body forming a housing cavity; a pair of end shields, having a uniform thickness, directly attached one to each end of the body; a pair of stopping plates directly attached one to each the end shield, the stopping plates being coplanar with the end shields; and a pair of flanges directly attached one to each the end shield and together with the stopping plates forming a hollow sleeve-shaped bearing housing, the flanges extending from the end shields fully into the housing cavity, and the flanges being profiled in part at an acute angle with respect to the stopping plates, in part in parallel to the stopping plates, and in part in perpendicular to the stopping plates.

### CROSS-REFERENCE TO RELATED APPLICATIONS

This application is a continuation of U.S. Ser. No. 12/141,258 and claims priority benefits to Chinese Patent Application No. 200720055139.1 filed Jul. 31, 2007. The contents of the aforementioned applications are incorporated herein by reference in their entirety.

### BACKGROUND OF THE INVENTION

1. Field of the Invention

The invention relates to an enclosure for an electric motor.

2. Description of the Related Art

Electric motors are widely used to drive appliances such as air conditioners, fans, air purifiers, and so on.

As illustrated in FIG. 1, in a motor case of prior art, a protrusion B is disposed outside the bearing housing A. The problem with this arrangement is that the protrusion B takes up certain space of the housing C, which makes it impossible for windings on both sides of the stator to be received outside the bearing housing A. This largely increases the axial and the radial size of the motor case. Moreover, the structure of the motor case is not compact and is complex, which increases its cost. Therefore, much opportunity remains for improvement in the area of electric motor case design.

### SUMMARY OF THE INVENTION

In view of the above-described problems, it is one objective of the invention to provide a motor case having a small distance between bearings so as to reduce vibration and noise of the motor that features a small radial size and volume so as to be compact and simple.

To achieve the above objectives, in accordance with one embodiment of the invention, provided is a motor case comprising a housing, a pair of end shields disposed one on each end of the housing, a cavity formed by the housing, and a pair of flanges extending from the center of the end shields; wherein the flanges extend into the cavity to form a bearing housing with two opening ends; and a space is formed between the cavity and the bearing housing.

In a class of this embodiment, one opening end of the bearing housing abuts against a pair of stopping plates.

In another class of this embodiment, the stopping plate is disposed on the end shield in a matter of buckling, riveting or welding.

In another class of this embodiment, a hole is disposed at the center of one of the stopping plates.

In another class of this embodiment, a sheet is connected between the end shield and the flanging.

In another class of this embodiment, the sheet is flat-shaped.

In another class of this embodiment, an angle between the sheet and the flanging is 90°.

In another class of this embodiment, the housing comprises a pair of cylinders.

In another class of this embodiment, the end shield is disposed at the end of the cylinder.

In another class of this embodiment, the end shield and the cylinder are integrally formed.

In another class of this embodiment, an assembling surface is disposed at an opening end of the cylinder.

In another class of this embodiment, the cylinders are connected together via the assembling surface.

In another class of this embodiment, the housing comprises one cylinder.

In another class of this embodiment, the end shields are disposed on both ends of the cylinder.

In another class of this embodiment, a bolt is disposed on the end shield, and operates to fix the motor.

In accordance with another embodiment of the invention provided is a motor case, comprising a body; a pair of end shields disposed one at each end of the body; and a pair of flanges extending from the center of the end shields on the inside of the body; wherein the flanges extend into the cavity to form a bearing house with two open ends.

In a class of this embodiment, one open end of the bearing house abuts against a pair of stopping plates.

In another class of this embodiment, the stopping plate is disposed directly on the end shield by buckling, rivet or welding.

In another class of this embodiment, a hole is disposed at the center of one of the stopping plates.

In another class of this embodiment, a sheet is connected between the end shield and the flanges within the cavity.

In another class of this embodiment, the sheet is flat-shaped.

In another class of this embodiment, an angle between the sheet and the flanges is about 90°.

In another class of this embodiment, the body comprises a pair of cylinders.

In a subclass of this class, the end shield is disposed at the end of the cylinders.

In another subclass of this class, the end shield and the cylinder are integrally formed.

In another subclass of this class, an assembling surface is disposed at an open end of the cylinder.

In another subclass of this class, the cylinders are connected together via the assembling surface.

In another class of this embodiment, the body comprises a cylinder.

In a subclass of this class, the end shields are disposed on both ends of the cylinder.

In another subclass of this class, a bolt is disposed on the end shield, and operates to fix the motor.

In accordance with another embodiment of the invention provided is a case for an electric motor, comprising: a body integrally formed with a pair of end shields and forming a housing cavity; a pair of stopping plates directly attached one to each end shield; and a pair of flanges extending one from each the end shields in part substantially in parallel to the stopping plates, and in part substantially perpendicular to the stopping plates, fully disposed on the inside of the body, and terminating in the housing cavity, whereby taken together with the stopping plates forming a bearing housing.

In a class of this embodiment, a hole is formed between the stopping plates, the hole being adapted for attaching bearings to the stopping plates.

In accordance with another embodiment of the invention provided is a case for an electric motor, comprising: a body integrally formed with a pair of end shields, the housing forming a housing cavity; a pair of stopping plates directly attached one to each the end shield; and a pair of flanges extending substantially perpendicularly to the stopping plates, one from a center of each the stopping plate into the housing cavity, fully disposed on the inside of the body, whereby forming a bearing housing between the flanges and the stopping plates.

In a class of this embodiment, the stopping plates are attached directly to the end shields by bolts, and a pair of reinforcement sheets extend from the bolts to the flanges, the reinforcement sheets being connected at one end to the bolt and at another end to the flanges, and the reinforcement sheets extending substantially in parallel to the stopping plates.

In a subclass of this class, a hole is formed between the stopping plates, the hole being adapted for attaching a bearing assembly to the stopping plates.

In accordance with another embodiment of the invention provided is a motor case, comprising a body forming a housing cavity; a pair of end shields, having a uniform thickness, directly attached one to each end of the body; a pair of stopping plates directly attached one to each the end shield, the stopping plates being coplanar or substantially coplanar with the end shields; and a pair of flanges directly attached one to each the end shield and together with the stopping plates forming a hollow sleeve-shaped bearing housing, the flanges extending from the end shields fully into the housing cavity, and the flanges being profiled in part at an acute angle with respect to the stopping plates, in part in parallel to the stopping plates, and in part in perpendicular to the stopping plates.

In a class of this embodiment, a hole is formed in the stopping plate, the hole being adapted for attaching bearings to the stopping plate.

In another class of this embodiment, the body is integrally-formed with the end shields.

In another class of this embodiment, a bolt is disposed on the end shield, and operates to fix the motor.

In another class of this embodiment, the stopping plates are attached directly to the end shields by bolts, and a pair of reinforcement sheets extend from the bolts to the flanges, the reinforcement sheets being connected at one end to the bolt and at another end to the flanges, and the reinforcement sheets extending substantially in parallel to the stopping plates.

In another class of this embodiment, a cavity for accommodating windings of the stator is formed between the body and the part of the flanges that is perpendicular to the stopping plates.

In a subclass of a class of this embodiment, the diameter of the hole is smaller than the diameter of the bearing housing.

In another class of this embodiment, the part of the flanges that is perpendicular to the stopping plates is solid, and there are no gaps therein.

In another class of this embodiment, the stopping plate is attached to the end shield by welding.

In another class of this embodiment, the stopping plate is attached to the end shield by riveting.

In a subclass of a class of this embodiment, the hole is disposed at the center of the stopping plate.

In a subclass of this embodiment, the bearing housing is fully solid and cylindrical.

In a class of this embodiment, the end shields are formed by stamping and stretching.

In another class of this embodiment, the end shields are separate from a rotor.

In another class of this embodiment, the cyclic hollow sleeve-shaped bearing house is formed via a stretching process.

In another class of this embodiment, a single stopping plate is disposed at each end of the housing.

In another class of this embodiment, the motor case comprises two and only two stopping plates.

In another class of this embodiment, the entire bearing housing is formed by the flanges.

In another class of this embodiment, the part of the flanges formed at an acute angle with respect to the stopping plates is bolted to the end shield.

In another class of this embodiment, the part of the flanges formed at an acute angle with respect to the stopping plates is bolted to the stopping plate.

In another class of this embodiment, the stopping plate is bolted to end shield.

In another class of this embodiment, the part of the flanges formed in parallel to the stopping plates is welded to the stopping plate.

Advantages of the invention include:
1) small distance between bearings can effectively reduce vibration and noise of the motor;
2) space between the bearing housing and the cavity can receive the wind wheels of the rotor and the windings of the stator; this keeps the radial size and the volume of the motor case small and the structure of the motor case compact and simple, and thus saves materials and reduces cost;
3) the stopping plate effectively prevents dust from entering the bearing housing; and
4) the flat-shaped sheet allows for a full utilization of space outside the bearing housing.

### BRIEF DESCRIPTION OF THE DRAWINGS

Detailed description will be given below with reference to accompanying drawings, in which

FIG. 1 is a schematic diagram of a motor case of prior art;

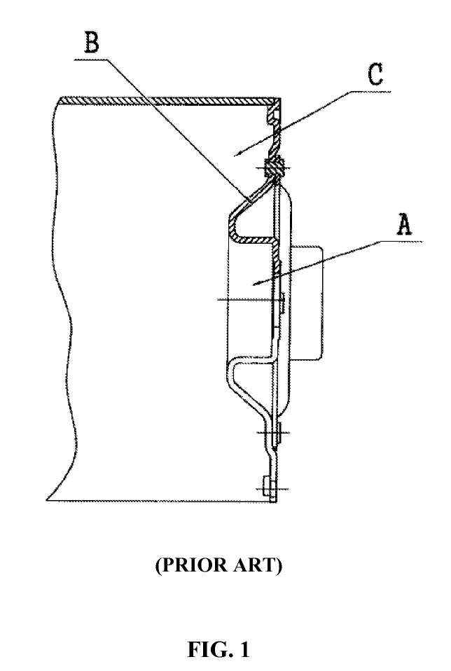

FIG. 2 is a schematic diagram of a motor case of one embodiment of the invention;

FIG. 3 is a schematic diagram of a motor case of another embodiment of the invention;

FIG. 4 is a schematic diagram of a motor in a motor case according to one embodiment of the invention as shown in FIG. 2; and

FIG. 5 is a schematic diagram of a motor in a motor case according to another embodiment of the invention as shown in FIG. 3.

### DETAILED DESCRIPTION OF THE EMBODIMENTS

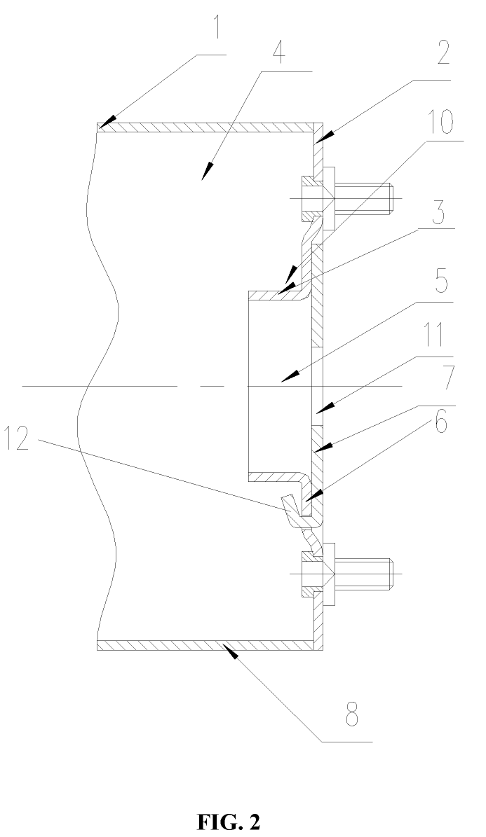

As shown in FIGS. 2-5, a motor case of the invention comprises a housing 1, a pair of end shields 2, a cavity 4 and a pair of flanges 3. The end shields 2 are disposed on both ends of the housing 1. The cavity 4 is formed by the housing 1. The flanges 3 extend from the center of the end shields 2, and extend into the cavity 4 to form a bearing housing 5 with two opening ends.

A space 10 is formed between the cavity 4 and the bearing housing 5, and operates to receive end portions of the stator and of the rotor of the motor.

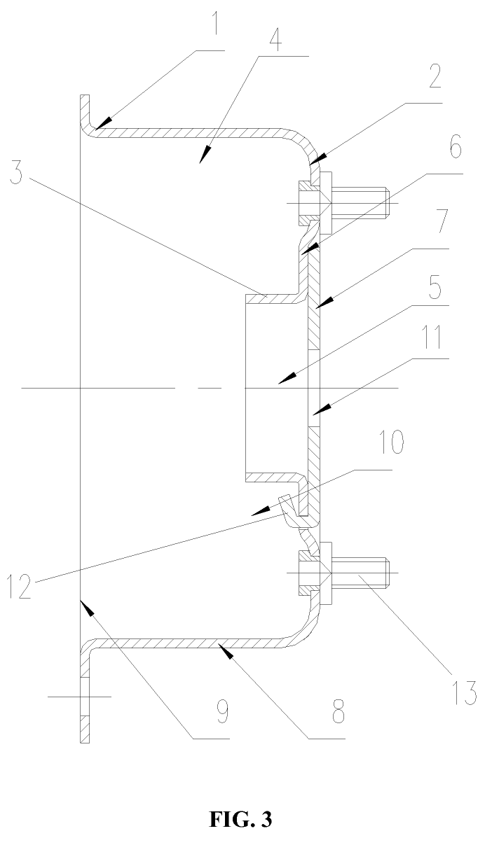

One opening end of the bearing housing 5 abuts against a pair of stopping plates 7. The stopping plate 7 is disposed on the end shield 2 by buckling, riveting or welding. As shown in FIGS. 2 and 3, a catch 12 is disposed on the edge of the stopping plate 7, and is fixed on the end shield 2.

Hole 11 is disposed at the center of one of the stopping plates 7.

Sheet 6 is connected between the end shield 2 and the flanging 3. In this embodiment, the sheet 6 is flat-shaped, and an angle between the sheet 6 and the flanging 3 is 90°.

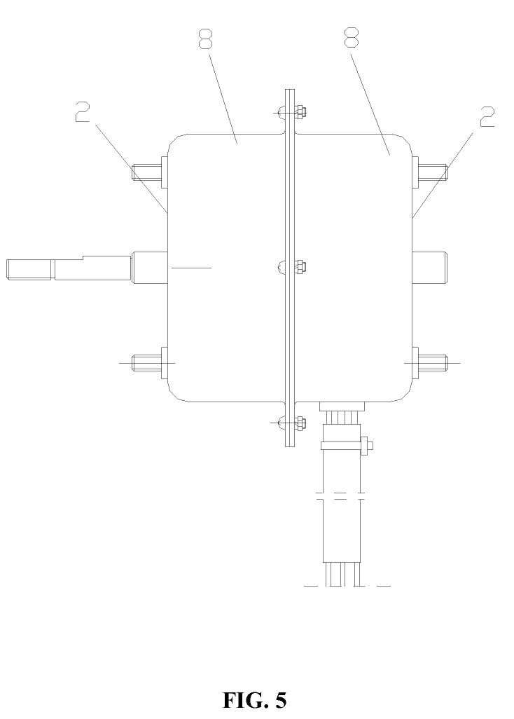

As shown in FIGS. 3 and 5, the housing 1 comprises a pair of cylinders 8. The end shield 2 is disposed at the end of the cylinder 8. The end shield 2 and the cylinder 8 are integrally formed. An assembling surface 9 is disposed at an opening end of the cylinder 8, and the cylinders 8 are connected together via the assembling surface 9.

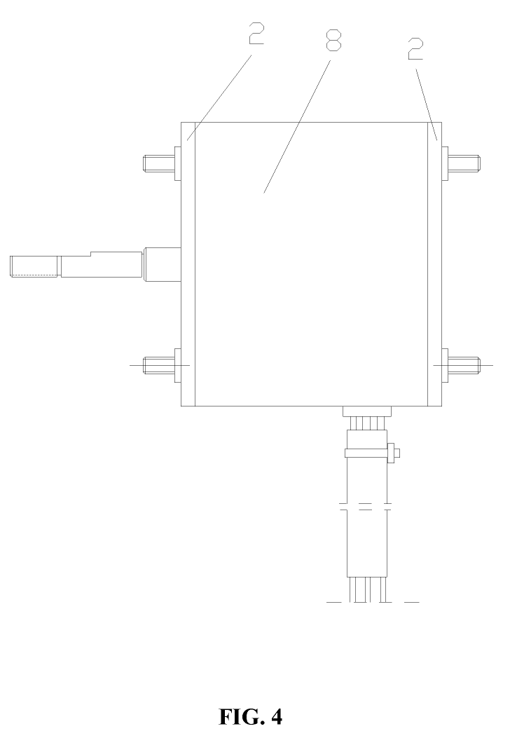

As shown in FIGS. 4 and 6, the housing 1 comprises a cylinder 8, and the end shields 2 are disposed on both ends of the cylinder 8. A bolt 13 is disposed on the end shield 2, and operates to fix the motor.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A motor case, comprising
a body forming a housing cavity;
a pair of end shields, having a uniform thickness, directly attached one to each end of said body;
a pair of stopping plates directly attached one to each said end shield, said stopping plates being coplanar with said end shields; and
a pair of flanges directly attached one to each said end shield and together with said stopping plates forming a hollow sleeve-shaped bearing housing, said flanges extending from said end shields into said housing cavity, and said flanges being profiled in part at an acute angle with respect to said stopping plates, in part in parallel to said stopping plates, and in part in perpendicular to said stopping plates.

2. The motor case of claim 1, wherein a hole is formed in said stopping plate, said hole being adapted for attaching bearings to said stopping plate.

3. The motor case of claim 1, wherein said body is integrally-formed with said end shields.

4. The motor case of claim 1, wherein a bolt is disposed on said end shield, and operates to fix a motor.

5. The motor case of claim 1, wherein said stopping plates are attached directly to said end shields by bolts, and a pair of reinforcement sheets extend from said bolts to said flanges, said reinforcement sheets being connected at one end to said bolt and at another end to said flanges, and said reinforcement sheets extending substantially in parallel to said stopping plates.

6. The motor case of claim 1, wherein a cavity for accommodating windings of the stator is formed between said body and the part of said flanges that is perpendicular to said stopping plates.

7. The motor case of claim 2, the diameter of said hole is smaller than the diameter of said bearing housing.

8. The motor case of claim 1, wherein the part of said flanges that is perpendicular to said stopping plates is solid, and there are no gaps therein.

9. The motor case of claim 1, wherein said stopping plate is attached to said end shield by welding.

10. The motor case of claim 1, wherein said stopping plate is attached to said end shield by riveting.

11. The motor case of claim 2, wherein said hole is disposed at the center of said stopping plate.

12. A motor case, comprising
a body forming a housing cavity;
a pair of end shields, having a uniform thickness, directly attached one to each end of said body;
a pair of stopping plates directly attached one to each said end shield, said stopping plates being coplanar with said end shields; and
a pair of flanges directly attached one to each said end shield and together with said stopping plates forming a hollow sleeve-shaped bearing housing, said flanges extending from said end shields into said housing cavity, and said flanges being profiled in part at an acute angle with respect to said stopping plates, in part in parallel to said stopping plates, and in part in perpendicular to said stopping plates,
wherein
a hole is formed in said stopping plate, said hole being adapted for attaching bearings to said stopping plate;
said body is integrally-formed with said end shields;
bolts are disposed on said end shield, and operate to fix a motor;
said stopping plates are attached directly to said end shields by bolts, and a pair of reinforcement sheets extend from said bolts to said flanges, said reinforcement sheets being connected at one end to said bolt and at another end to said flanges, and said reinforcement sheets extending substantially in parallel to said stopping plates;
a cavity for accommodating windings of the stator is formed between said body and the part of said flanges that is perpendicular to said stopping plates;
the diameter of said hole is smaller than the diameter of said bearing housing;
the part of said flanges that is perpendicular to said stopping plates is solid, and there are no gaps therein; and
said stopping plate is attached to said end shield by welding.

13. The motor case of claim 12, wherein said bearing house is cyclic hollow sleeve-shaped is formed via a stretching process.

14. The motor of claim 13, wherein the motor case comprises two and only two stopping plates.

15. The motor of claim 14, wherein the part of the flanges formed at an acute angle with respect to the stopping plates is bolted to the end shield.

16. The motor of claim 15, wherein the part of the flanges formed in parallel to the stopping plates is welded to the stopping plate.

17. A motor case, comprising
a body;
a pair of end shields disposed on both ends of the body;
said end shields are formed via a stamping and stretching process;
a cavity formed inside said body; and
a pair of flanges extending from the center of the end shields;
wherein
the flanging extend into the cavity to form a bearing house with two opening ends; and
a space for receiving stator windings is formed between the cavity and the bearing house.
